(19) United States
(12) Patent Application Publication
(10) Pub. No.: US 2007/0048606 A1
(43) Pub. Date: Mar. 1, 2007

(54) Non-aqueous electrolyte secondary battery

(76) Inventors: Keiji Saisho, Kobe-city (JP); Hidekazu Yamamoto, Kobe-city (JP); Yoshio Kato, Hirakata-city (JP); Tetsuyuki Murata, Kobe-city (JP)

Correspondence Address: KUBOVCIK & KUBOVCIK, SUITE 710, 900 17TH STREET NW, WASHINGTON, DC, 20006, US

(21) Appl. No.: 11/512,150

(22) Filed: Aug. 30, 2006

(30) Foreign Application Priority Data
Aug. 31, 2005 (JP) 2005-252173
Jul. 31, 2006 (JP) 2006-208327
Aug. 11, 2006 (JP) 2006-219318

(51) Int. Cl. H01M 10/40; H01M 4/58

(52) U.S. Cl. 429/199; 429/218.1

(57) ABSTRACT

To improve cycle characteristics in a non-aqueous electrolyte secondary battery containing silicon as a negative electrode active material. A non-aqueous electrolyte secondary battery comprising a negative electrode made of a negative electrode active material containing silicon, a positive electrode, and a non-aqueous electrolyte containing an electrolyte salt and a solvent, wherein a first electrolyte salt containing boron and fluorine and a second electrolyte salt having a decomposition rate on the surface of the negative electrode during charging and discharging, which is lower than that of the first electrolyte salt, are used as the electrolyte salt.

### BACKGROUND OF THE INVENTION

1. Field of the Invention

The present invention relates to a non-aqueous electrolyte secondary battery and, more particularly, to a non-aqueous electrolyte secondary battery containing silicon as a negative electrode active material.

2. Description of the Invention

Recently, size reduction and weight reduction of portable electrical equipments and machineries have remarkably advanced and also power consumption has increased in accordance with multi-functional tendencies. Therefore, it has been requested strongly to achieve weight reduction and high capacity of a lithium secondary battery used as a power source.

To comply with such a request, there have recently been proposed alloy-based negative electrodes made of materials such as silicon, which are excellent in charge and discharge capacity per unit mass and unit volume as compared with a carbon negative electrode.

Among negative electrodes made of these materials, intense interest has been shown towards negative electrodes wherein a thin film made of an alloy-based active material such as silicon is formed on a current collector using a CVD method, a sputtering method, an evaporation method, a thermal spraying method or a plating method, which have high charge and discharge capacity and are excellent in cycle characteristics. It is known that electrodes having such a structure that an active material thin film is separated in a columnar shape by a nick formed in the thickness direction and the bottom portion of the columnar portion is closely contacted with a current collector are excellent in cycle characteristics because stress produced by expansion and contraction during charging and discharging can be relaxed by voids in the vicinity of the columnar portion.

However, even when using such as negative electrode, deterioration gradually proceeds by the reaction between an active material and an electrolytic solution during charge and discharge cycle for a longer period or charge and discharge cycle in a high-temperature environment.

As the method for improving charge and discharge cycle in the electrode described above, for example, a method of adding vinylene carbonate in an electrolytic solution is proposed (International Publication Pamphlet, WO2002/058182, etc).

However, vinylene carbonate added at an initial stage was quickly consumed and it was difficult to continuously maintain the effect.

### SUMMARY OF THE INVENTION

An object of the present invention is to provide a non-aqueous electrolyte secondary battery containing silicon as a negative electrode active material, which has improved cycle characteristics.

The non-aqueous electrolyte secondary battery of the present invention includes a negative electrode made of a negative electrode active material containing silicon, a positive electrode, and a non-aqueous electrolyte containing an electrolyte salt and a solvent, wherein a first electrolyte salt containing boron and fluorine and a second electrolyte salt having a decomposition rate on the surface of the negative electrode during charging and discharging, which is lower than that of the first electrolyte salt, are used as the electrolyte salt.

In the present invention, a first electrolyte salt containing boron and fluorine is used as an electrolyte salt. The addition of the first electrolyte salt to the non-aqueous electrolyte enables suppression of a negative electrode active material during charge and discharge cycle, and thus good charge and discharge cycle characteristics are attained. As described hereinafter, the first electrolyte salt is reacted with the surface of the negative electrode and is consumed during charge and discharge cycle. It may be considered that, since boron and fluorine are detected on the surface of the negative electrode during charge and discharge cycle, the first electrolyte salt is reacted with the surface of the negative electrode during charge and discharge cycle to form some coat on the surface of the negative electrode. It is deemed that the formation of the coat suppresses deterioration of the negative electrode active material, and thus good charge and discharge cycle characteristics are attained.

Since the first electrolyte salt is consumed during charge and discharge cycle, a second electrolyte salt is added so as to make up for the consumed amount in the present invention. The second electrolyte salt is an electrolyte salt having a decomposition rate on the surface of the negative electrode during charging and discharging, which is lower than that of the first electrolyte salt. Therefore, charge and discharge cycle characteristics can be improved by containing the second electrolyte salt in the non-aqueous electrolyte without lack of the electrolyte salt.

The first electrolyte salt used in the present invention contains boron and fluorine and typical examples thereof include LiBF₄. Also the first electrolyte salt includes boron-containing fluoride salts such as Li[B(CF₃)₄], Li[BF(CF₃)₃], LiBF₂(CF₃)₂, LiBF₃(CF₃), LiB(C₂F₅)₄, LiBF(C₂F₅)₃, LiBF₂(C₂F₅)₂ and LiBF₃(C₂F₅), a portion of fluorine atoms of LiBF₄ being substituted with a perfluoroalkyl group. Also the first electrolyte salt includes LiBFₘ(C₆H₅.ₙFₙ)₄₋ₘ (m is an integer of 0 to 3, and n is an integer of 1 to 5), LiBF₂(C₂O₄) and lithium.bis[5-fluoro-2-oleatebenzenesulfonate(2-)O,O′]borate.

The second electrolyte salt used in the present invention is not specifically limited as far as the decomposition rate on the surface of the negative electrode during charging and discharging is lower than that of the first electrolyte salt, and examples thereof include fluorine-containing organic lithium salts, for example, inorganic fluoride salt such as LiPF₆, LiAsF₆ or LiAlF₄; perhalogenate such as LiClO₄, LiBrO₄ or LiIO₄; organic sulfonic acid salt such as LiCF₃SO₃; perfluoroalkylsulfonic acid imide such as LiN(CF₃SO₂)₂, LiN(C₂F₅SO₂)₂ or LiN(CF₃SO₂) (C₄F₉SO₂); methide perfluoroalkylsulfonate such as LiC(CF₃SO₂)₃; and inorganic fluoride salt, a portion of fluorine atoms being substituted with a perfluoroalkyl group, such as LiPF₃(CF₃)₃, LiPF₂(C₂F₅)₄ or LiPF₃(C₂F₅)₃.

In the present invention, the content of the first electrolyte salt in the non-aqueous electrolyte during battery assembling is preferably within a range from 0.1 to 2.0 mol/liter. When the content is less than 0.1 mol/liter, there may not be exerted the sufficient effect of suppressing deterioration of the active material thereby to improve charge and discharge cycle characteristics. On the other hand, when the content exceeds 2.0 mol/liter, viscosity of the non-aqueous electrolyte increases and thus it becomes difficult to sufficiently fill the electrode with the non-aqueous electrolyte, resulting in deterioration of battery characteristics. The content is more preferably within a range from 0.5 to 1.5 mol/liter.

The content of the second electrolyte salt in the non-aqueous electrolyte during battery assembling is preferably within a range from 0.1 to 1.5 mol/liter. When the content is less than 0.1 mol/liter, it may be insufficient to make up for the first electrolyte salt to be consumed during charge and discharge cycle and sufficient ionic conductivity of the non-aqueous electrolyte can not be obtained, resulting in deterioration of battery characteristics. On the other hand, when the content is more than 1.5 mol/liter, viscosity of the non-aqueous electrolyte increases and it becomes difficult to sufficiently fill the electrode, resulting in deterioration of battery characteristics. The content of the second electrolyte salt is more preferably within a range from 0.1 to 1.0 mol/liter.

A mixing ratio of the first electrolyte salt to the second electrolyte salt during battery assembling is preferably within a range from 1:20 to 20:1 in terms of a weight ratio (first electrolyte salt:second electrolyte salt). When the content of the first electrolyte salt relatively becomes too large, ionic conductivity may be lowered during charge and discharge cycle, and thus battery characteristics may deteriorate. On the other hand, when the content of the second electrolyte salt relatively becomes too large, the content of the first electrolyte salt relatively decreases and thus sufficient effect of improving charge and discharge cycle may not be obtained.

As the non-aqueous electrolyte solvent in the present invention, a non-aqueous solvent used commonly in a non-aqueous electrolyte secondary battery can be used. Examples thereof include cyclic carbonates, chain carbonates, lactone compounds (cyclic carboxylic acid esters), chain carboxylic acid esters, cyclic ethers, chain ethers and sulfur-containing organic solvents. Among these solvents, cyclic carbonates having 3 to 9 carbon atoms, chain carbonates, lactone compounds (cyclic carboxylic acid esters), chain carboxylic acid esters, cyclic ethers and chain ethers are preferably used, and cyclic carbonates having 3 to 9 carbon atoms and/or chain carbonates are used particularly preferably.

The non-aqueous electrolyte in the present invention preferably contains vinylene carbonate. When vinylene carbonate is contained, cycle characteristics can be further improved. The content of vinylene carbonate is within a range from 0.1 to 10% by weight in the non-aqueous electrolyte. When the content of vinylene carbonate is less than 0.1% by weight, sufficient effect of improving cycle characteristics by the addition of vinylene carbonate may not be exerted. On the other hand, when the content is more than 10% by weight, the effect in proportion to an increase in content can not be obtained and it becomes economically disadvantageous.

When the non-aqueous electrolyte contains vinylene carbonate, consumption of LiBF₄ in the non-aqueous electrolyte can be suppressed and charge and discharge cycle characteristics can be enhanced. In case the non-aqueous electrolyte contains vinylene carbonate, the concentration of LiBF₄ in the non-aqueous electrolyte is preferably 10%, and more preferably 20% more than the concentration before charge and discharge cycle, when discharge capacity is reduced to 80% of the initial discharge capacity after charge and discharge cycle, that is, when the capacity retention rate is reduced to 80%. The concentration of LiBF₄ is preferably more than 0.05 mol/liter, and more preferably 0.1 mol/liter. By maintaining the concentration of LiBF₄ after charge and discharge cycle as described above, good charge and discharge cycle characteristics can be obtained.

The negative electrode in the present invention is a negative electrode made of a negative electrode active material containing silicon and, as the negative electrode, there can be preferably used a negative electrode obtained by forming a thin film containing silicon such as amorphous silicon thin film or noncrystalline silicon thin film on a negative electrode current collector composed of a metal foil such as copper foil using a CVD method, a sputtering method, an evaporation method, a thermal spraying method or a plating method. The thin film containing silicon may be an alloy thin film made of silicon and cobalt, iron or zirconium. The method for producing these negative electrodes is disclosed in detail in International Publication Pamphlet, WO2002/058182.

In the negative electrode, thin film is separated in a columnar shape by a nick formed in the thickness direction and the bottom portion of the columnar portion is closely contacted with the negative electrode current collector. With such an electrode structure, a change in volume of expansion and contraction of an active material caused during charge and discharge cycle can be received at voids in the vicinity of the columnar portion, and thus stress produced during the charge and discharge reaction is relaxed and good charge and discharge cycle characteristics can be obtained. The nick in the thickness direction is commonly formed by the charge and discharge reaction.

When the silicon thin film or the silicon alloy thin film is used as an active material, an oxygen-containing silicon thin film or silicon alloy thin film may be formed by introducing oxygen during the formation of a thin film. By using an oxygen-introduced silicon thin film or silicon alloy thin film, charge and discharge cycle characteristics can be further enhanced. The content of oxygen is preferably within a range from 10 to 30% by weight.

The negative electrode of the present invention may be formed of active material particles containing silicon. A negative electrode can be formed by coating a slurry containing active material particles and a binder on a current collector. Examples of the active material particles include silicon particles and silicon alloy particles.

The positive electrode active material used in the present invention is not specifically limited as far as it can be used in a non-aqueous electrolyte secondary battery, and examples thereof include lithium transition metal oxide such as lithium cobaltate, lithium manganate or lithium nickelate. These oxides may be used alone or in combination.

According to the present invention, in a non-aqueous electrolyte secondary battery containing silicon as a negative electrode active material, deterioration of an active material during charge and discharge cycle can be remarkably suppressed thereby to remarkably improve cycle characteristics.

### BRIEF DESCRIPTION OF THE DRAWINGS

FIG. 1 is a graph showing a relation between the number of cycles and the capacity retention rate in each cycle in Examples 1 to 3.

FIG. 2 is a graph showing a relation between the number of cycles and the capacity retention rate in each cycle in Examples 4 to 9.

FIG. 3 is a graph showing a relation between the number of cycles and the capacity retention rate in each cycle in Examples 2 and 3.

FIG. 4 is a graph showing a relation between the capacity retention rate and the molar ratio LiBF₄/LiPF₆ in Examples 2 and 3.

FIG. 5 is a graph showing a relation between the number of cycles and the molar ratio LiBF₄/LiPF₆ in Examples 2 and 3.

FIG. 6 is a graph showing a relation between the capacity retention rate and the amount of a F-containing product on the surface of the negative electrode in Examples 2 and 3.

FIG. 7 is a graph showing a relation between the number of cycles and the capacity retention rate in each cycle in Examples 2, 3 and 10.

FIG. 8 is a graph showing a relation between the number of cycles and the molar ratio LiBF₄/LiPF₆ in Examples 2, 3 and 10.

FIG. 9 is a graph showing a relation between the capacity retention rate and the molar ratio LiBF₄/LiPF₆ in Examples 2, 3 and 10.

### DESCRIPTION OF THE PREFERRED EXAMPLES

The present invention will now be described in detail by way of examples, but the present invention is not limited to the following examples and modifications can be made without departing from the scope of the present invention.

<Test 1>

### Example 1

[Production of Negative Electrode]

On an electrolytic copper foil having a thickness of 18 μm and a surface roughness Ra of 0.188 μm, a 5 μm thick amorphous silicon thin film was formed by an RF sputtering method under the following conditions: sputter gas (Ar) flow rate; 100 sccm, substrate temperature; room temperature (without heating), reaction pressure; 0.133 Pa, and high-frequency power; 200 W. The resulting product was used as a negative electrode.

Both surfaces of the electrolytic copper foil having a thickness of 18 μm and a surface roughness Ra of 0.188 μm was irradiated with Ar ion beam under a pressure of 0.05 Pa at ion current density of 0.27 mA/cm². After evacuation to 1×10⁻³ Pa or less, a thin film was formed by an electron-beam evaporation method under the following conditions: substrate temperature; room temperature (without heating) and applied power; 3.5 kW, using single crystal silicon as an evaporation material. The resulting product was used as a negative electrode.

[Production of Positive Electrode]

Lithium cobaltate as a positive electrode active material, ketjen black as a conductive auxiliary and a fluororesin as a binder were mixed in a mixing ratio of 90:5:5 and the mixture was dissolved in N-methyl-2-pyrrolidone (NMP) to give a paste.

This paste was uniformly coated on both surfaces of a 20 μm thick aluminum foil using a doctor blade method. The coated aluminum foil was subjected to a vacuum heat treatment in a heated dryer at a temperature within a range from 100 to 150° C. thereby to remove NMP, and then rolled by a roll press machine to obtain a 0.16 mm thick positive electrode.

[Production of Lithium Secondary Battery]

The positive electrode and the negative electrode obtained by the above method were cut into electrodes each having a predetermined size and a current collecting tab was attached to a metal foil as a current collector. A 20 μm thick separator made of a polyolefin-based microporous film was interposed between these electrodes and the resulting laminate was wound up and, after fixing outermost circumference with a tape to give a spiral-shaped electrode body. The spiral-shaped electrode body was collapsed to obtain the objective spiral-shaped electrode body.

This spiral-shaped electrode body was inserted into a casing made of a laminate material produced by laminating PET (polyethylene terephthalate) and aluminum, thereby to form a state in which the current collecting tab protrudes from an aperture portion.

In a mixed solvent prepared by mixing ethylene carbonate (EC) with diethyl carbonate (DEC) in a volume ratio of 3:7, LiBF₄ and LiPF₆ (each 0.5 mol/liter (M)) as electrolyte salts were dissolved to prepare an electrolytic solution.

5 ml of the electrolytic solution was injected through the aperture portion of the casing and the aperture portion was sealed to obtain a lithium secondary battery. The resulting battery had discharge capacity of 250 mAh.

### Example 2

In the same manner, except that the silicon thin film was formed by an electron beam method in place of the RF sputtering method in the production of the negative electrode, a negative electrode was produced.

### Example 3

In the same manner as in Example 2, except that an electrolytic solution containing 2% by weight of vinylene carbonate (VC) added therein was used, a lithium secondary battery was produced.

### Comparative Example 1

In the same manner as in Example 1, except that 1 mol/liter of LiPF₆ was used as the electrolyte salt of the electrolytic solution and LiBF₄ was not added, a lithium secondary battery was produced.

### Comparative Example 2

In the same manner as in Example 2, except that 1 mol/liter of LiPF₆ was used as the electrolyte salt of the electrolytic solution and LiBF₄ was not added, a lithium secondary battery was produced.

Electrolyte salts, methods for producing an electrode and additives used in Examples 1 to 3 and Comparative Examples 1 to 2 are summarized in Table 1.

TABLE 1

| | | Method for | |
|---|---|---|---|
| | Electrolyte Salt | Producing Electrode | Additive |
| Ex. 1 | 0.5M LiPF₆ + 0.5M LiBF₄ | Sputtering Method | None |
| Ex. 2 | 0.5M LiPF₆ + 0.5M LiBF₄ | Evaporation Method | None |
| Ex. 3 | 0.5M LiPF₆ + 0.5M LiBF₄ | Evaporation Method | 2% by |
| | | | Weight of |
| | | | VC |
| Comp. | 1.0M LiPF₆ | Sputtering Method | None |
| Ex. 1 | | | |
| Comp. | 1.0M LiPF₆ | Evaporation Method | None |
| Ex. 2 | | | |

[Charge and Discharge Cycle Test]

Each of the batteries of Examples 1 to 3 and Comparative Examples 1 to 2 produced as described above was charged at a charge current of 250 mA until a battery voltage reached 4.2 V and charged at a constant voltage of 4.2 V until a current value reached 13 mA, and then discharged at a current value of 250 mA until the battery voltage reached 2.75 V (1 cycle) and 200 cycles of this charge and discharge cycle were repeated. A ratio of the proportion of discharge capacity at each cycle to discharge capacity at 1 cycle was taken as a capacity retention rate (%) and the number of cycles when the capacity retention rate reaches 60% is shown in Table 2.

TABLE 2

| | Number of Cycles to Reach |
|---|---|
| | Capacity Retention Rate of 60% |
| Ex. 1 | 45 |
| Ex. 2 | 140 |
| Ex. 3 | 195 |
| Comp. Ex. 1 | 38 |
| Comp. Ex. 2 | 86 |

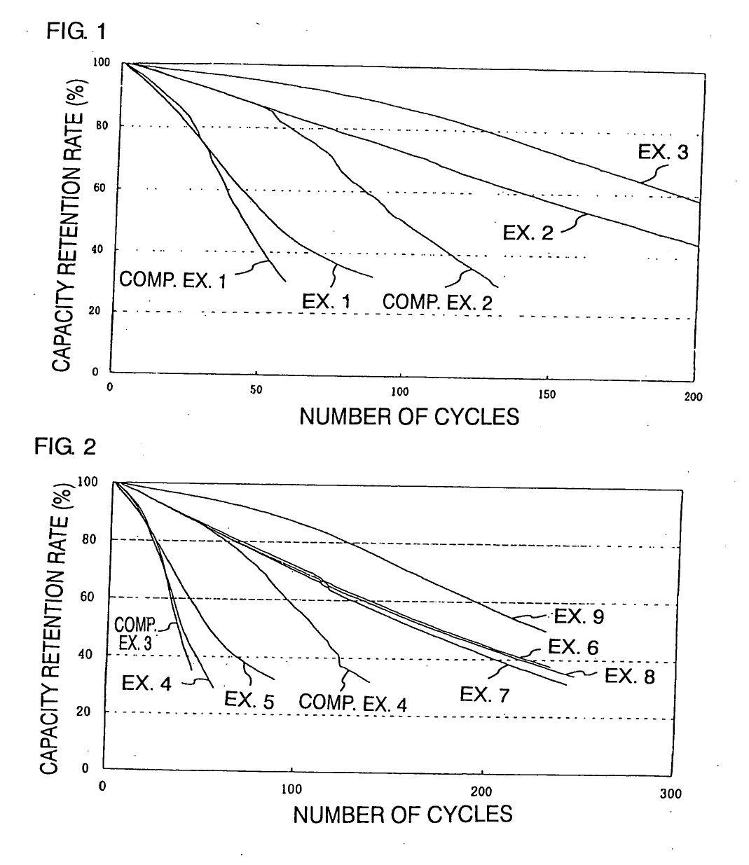

The relation between the number of cycles and the capacity retention rate in each cycle is shown in FIG. 1.

As is apparent from the results shown in Table 2 and FIG. 1, comparing Example 1 and Comparative Example 1 in which the thin film was formed by a sputtering method, in case of Example in which LiBF₄ was used as the electrolyte salt, excellent cycle characteristics are obtained as compared with Comparative Example 1. Comparing Example 2 and 3 and Comparative Example 2 in which the thin film was formed by an evaporation method, in case of Examples 2 and 3 in which LiBF₄ was used as the electrolyte salt, excellent cycle characteristics are obtained as compared with Comparative Example 2. Consequently, it is found that cycle characteristics are improved by using LiBF₄.

Comparing Example 2 with Example 3, good cycle characteristics are obtained in Example 3 in which vinylene carbonate is added. Consequently, cycle characteristics are further improved by adding vinylene carbonate.

[Confirmation of Consumption of LiBF₄]

Under the same conditions, a charge and discharge cycle test was conducted until the capacity retention rate becomes 30% using the battery of Example 2 and the contents of LiBF₄ before and after charge and discharge cycle.

The electrolytic solution in the battery penetrates into the separator and the electrodes and the electrolytic solution can not be collected only by opening. Therefore, a portion of the laminate casing was opened and 1 ml of DEC was injected from the opened portion and, after standing for 10 minutes, the electrolytic solution containing DEC added therein was collected. The collected electrolytic solution was analyzed by ion chromatography and the concentration of the electrolyte salt in the electrolytic solution was measured. The results are shown in Table 3. In Table 3, a relative ratio means a value standardized assumed that the concentration of LiPF₆ is 100%.

TABLE 3

| | LiPF₆ | LiBF₄ |
|---|---|---|
| Amount Added on Production | 0.5M | 0.5M |
| (Absolute Value) | | |
| Amount Added on Production | 100% | 100% |
| (Relative Value) | | |
| Before Cycle (Relative Ratio) | 100% | 96% |
| After Cycle | 100% | 1.9% |
| (Relative Ratio) | | |

As is apparent from Table 3, the amounts of LiPF₆ and LiBF₄ added in the production of a battery are almost the same in an initial state, while the proportion of LiBF₄ drastically decreased and decreased to 1/50 of LiPF₆ or less of the proportion. Consequently, LiBF₄ is consumed during charge and discharge cycle.

With respect to the surface of the negative electrode after the cycle test, the amounts of boron and phosphorus were determined. As a result, boron corresponding to 70% of LiBF₄, which is considered to be consumed (decomposed) in the cycle test, is detected on the surface of the negative electrode. As a result of a comparison with phosphorus measured by the same determination method, it was confirmed that very large amount of boron is present on the surface of the negative electrode.

Also the amount of fluorine, which is present on the surface of the negative electrode after the cycle test, was determined. As a result, fluorine corresponding to 88% of the amount of fluorine, which is produced assumed that entire fluorine was produced by decomposition of LiBF₄, is detected on the surface of the negative electrode. This amount is very large as compared with the amount of fluorine detected when LiPF₆ is used alone as the electrolyte salt.

From the above results, it is considered that, in a lithium secondary battery containing LiBF₄ as an electrolyte salt, LiBF₄ is decomposed on the surface of the silicon negative electrode during charge and discharge cycle and the decomposition product adheres onto the surface of the negative electrode. By adding LiBF₄ as the electrolyte salt, charge and discharge cycle characteristics are remarkably improved. It is deemed that charge and discharge cycle characteristics are improved by adhesion of the decomposition product of LiBF₄ onto the surface of the negative electrode.

<Test 2>

### Examples 4 to 9 and Comparative Examples 3 to 4

Using a non-aqueous electrolyte prepared so as to adjust to the concentration of the electrolyte salt shown in Table 3, a lithium secondary battery was produced in the same manner as described above. In the production of a negative electrode, an amorphous silicon thin film was formed by a sputtering method.

In Table 4, “contained” in the column of “oxygen” means that a thin film is formed under an atmosphere in which an oxygen gas flows through a sputter gas at a flow rate 10 sccm in case of forming a thin film using an RF sputtering method.

TABLE 4

| | Electrolyte Salt | Additive | Oxygen |
|---|---|---|---|
| Comp. Ex. 3 | 1.0M LiPF₆ | Not Contained | Not |
| Ex. 4 | 0.5M LiPF₆ + 0.5M LiBF₄ | | Contained |
| Ex. 5 | 0.1M LiPF₆ + 0.9M LiBF₄ | | |
| Comp Ex. 4 | 1.0M LiPF₆ | | Contained |
| Ex. 6 | 0.5M LiPF₆ + 0.5M LiBF₄ | | |
| Ex. 7 | 0.8M LiPF₆ + 0.5M LiBF₄ | | |
| Ex. 8 | 1.0M LiPF₆ + 0.5M LiBF₄ | | |
| Ex. 9 | 0.5M LiPF₆ + 0.5M LiBF₄ | 2% by Weight of | |
| | | VC | |

With respect to each silicon thin film formed under the conditions of “oxygen is not contained” and “oxygen is contained”, oxygen concentration was measured by XPS. With respect to the thin film formed under the condition of “oxygen is not contained”, the content of oxygen was about 2% by weight or less, whereas, about 20% by weight of oxygen was introduced into the silicon thin film with respect to the thin film formed under the condition of “oxygen is contained”.

[Charge and Discharge Cycle Test]

In the same manner as in Test 1, a charge and discharge cycle test was conducted. The number of cycles required until the capacity retention rate reached 50% was determined. The results are shown in Table 5.

TABLE 5

| | Number of Cycles to Reach |
|---|---|
| | Capacity Retention Rate of 50% |
| Comp. Ex. 3 | 37 |
| Ex. 4 | 40 |
| Ex. 5 | 51 |
| Comp. Ex. 4 | 110 |
| Ex. 6 | 177 |
| Ex. 7 | 166 |
| Ex. 8 | 174 |
| Ex. 9 | 231 |

The relation between the number of cycles and the capacity retention rate in each cycle is shown in FIG. 2

As is apparent from Table 5 and FIG. 2, in Examples 4 to 5 and Comparative Example 3 produced under the condition of “oxygen is not contained”, Examples 4 and 5 containing LiBF₄ as the electrolyte salt show good charge and discharge cycle characteristics as compared with Comparative Example 3. In Examples 6 to 9 and Comparative Example 4 produced under the condition of “oxygen is contained”, Examples 6 to 9 containing LiBF₄ as the electrolyte salt show good charge and discharge cycle characteristics as compared with Comparative Example 4.

Comparing Examples 4 to 5 produced under the condition of “oxygen is not contained” with Examples 6 to 9 under the condition of “oxygen is contained”, Examples 6 to 9 under the condition of “oxygen is contained” show good charge and discharge cycle characteristics. Consequently, it is found that charge and discharge cycle characteristics can be further improved by using a silicon thin film containing oxygen.

Example 9 containing vinylene carbonate shows most excellent charge and discharge cycle characteristics. Consequently, it is found that charge and discharge cycle characteristics can be improved by containing vinylene carbonate

<Test 3>

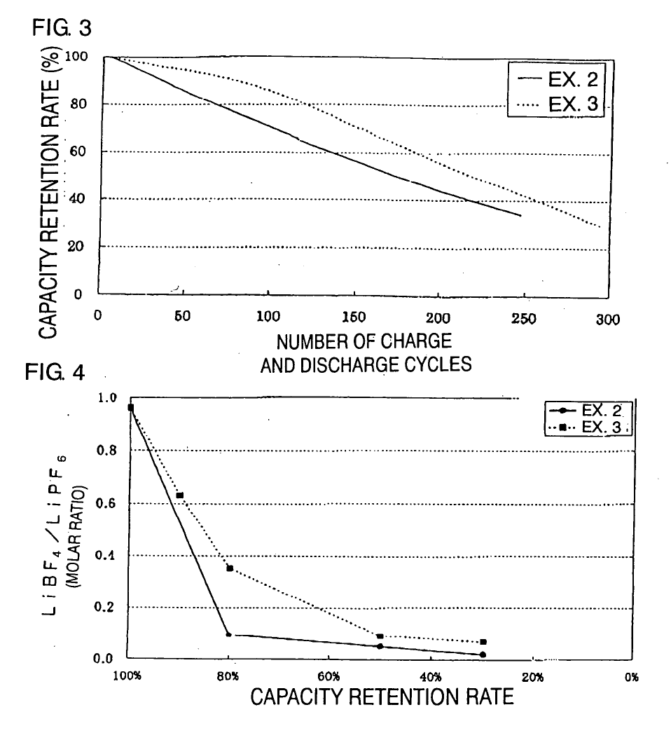

FIG. 3 is a graph showing the capacity retention rate up to 300 cycles of each battery of Example 2 and Example 3 in Test 1.

FIG. 4 is a graph showing a relation between the molar ratio (LiBF₄/LiPF₆) in a non-aqueous electrolyte of each battery of Examples 2 and 3 and the capacity retention rate.

In the measurement of the concentrations of LiBF₄ and LiPF₆, since the amount of electrolytic solution required for analysis could not be obtained after cycles for a long period, the electrolytic solution was extracted by adding DEC in the battery and ion chromatography was measured using the extract solution. Therefore, the concentrations of LiPF₆ and LiBF₄ in each battery are not directly measured after each cycle, and a concentration ratio in each battery is determined by measuring each concentration in the extract solution diluted in the same proportion in case of both LiPF₆ and LiBF₄.

As is apparent from FIG. 4, in Example 2 containing no vinylene carbonate, a large amount of LiBF₄ is consumed until the capacity retention rate is reduced to 80% and the concentration quickly decreases. To the contrary, in Example 3 containing vinylene carbonate, the concentration of LiBF₄ gradually decreases. Therefore, it is considered that a decrease in concentration of LiBF₄ during charge and discharge cycle can be suppressed by containing vinylene carbonate, and thus charge and discharge cycle characteristics are enhanced.

Although the details are not shown, ion chromatography of the solution extracted from the electrolytic solution in the battery and analysis of the decomposition product on the electrode surface reveal that the concentration of LiPF₆ in the non-aqueous electrolyte is scarcely changed by charge and discharge cycle.

FIG. 5 is a graph showing a relation between the molar ratio LiBF₄/LiPF₆ and the number of charge and discharge cycles. It is found that, in the battery containing vinylene carbonate of Example 3, consumption of LiBF₄ during charge and discharge cycle is suppressed as compared with the battery containing no vinylene carbonate of Example 2.

In the batteries of Example 2 and Example 3, the concentration of LiBF₄ before initiation of charge and discharge cycle (initial concentration), the concentration of LiBF₄ when the capacity retention rate reached 80% after charge and discharge cycle, and the residual amount of LiBF₄ to the initial concentration are as shown in Table 6.

TABLE 6

| | Before | Time When Reached Capacity | |
|---|---|---|---|
| | Charge and | Retention Rate of 80% | |
| | Discharge Cycle | | Residual Amount of |
| | Concentration | Concentration | LiBF₄ Relative to |
| | of LiBF₄ | of LiBF₄ | Initial Concentration |
| Ex. 2 | 0.50M | 0.05M | 10% |
| Ex. 3 | 0.50M | 0.18M | 36% |

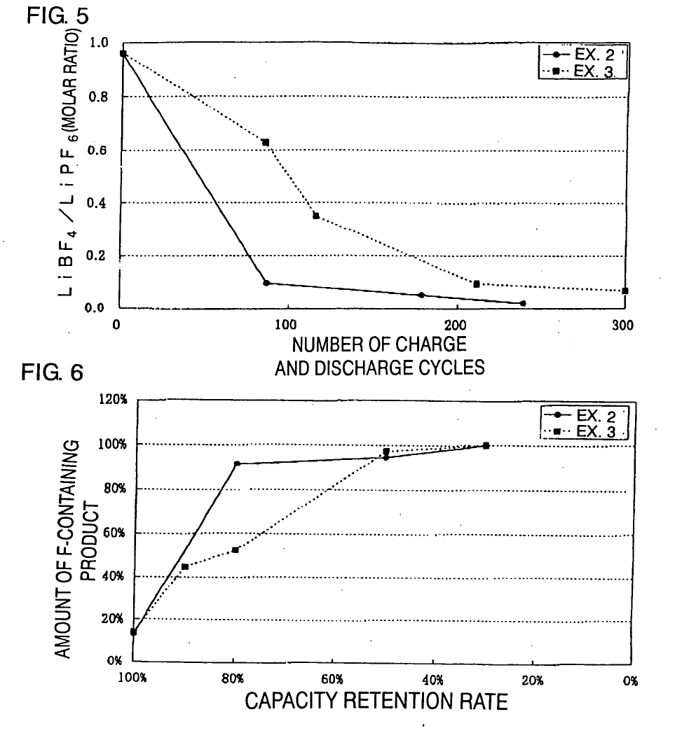

FIG. 6 is a graph showing a relation between the amount of a F-containing product on the surface of the negative electrode and the capacity retention rate. The amount of the F-containing product on the surface of the negative electrode was determined by removing the negative electrode from the battery, extracting the produced adhered to the negative electrode with water and measuring the amount of F using an ion chromatography method. The amount of the F-containing product is a relative value assumed that the value when the capacity retention rate is 30% is 100%. As is apparent from FIG. 6, in Example 2 containing no vinylene carbonate, large amount of the F-containing product is produced on the surface of the negative electrode until the capacity retention rate reaches 80%. To the contrary, in Example 3 containing vinylene carbonate, the amount of F-containing product monotonously increases until the capacity retention rate reaches 50%.

In Example 2 and Example 3, Si is used as the negative electrode active material and it is considered that the surface of the negative electrode is decomposed by LiBF₄ and the decomposition product adheres onto the surface of the negative electrode, and thus the side reaction between the surface of the negative electrode and the electrolytic solution is suppressed and deterioration of cycle characteristics are suppressed. Although the details of the decomposition product are not clear, for example, it is considered to be LiF. However, when the decomposition of LiBF₄ proceeds in the amount required to suppress deterioration of cycle characteristics or more, the product typified by LiF is present on the surface of the negative electrode, thus causing deterioration of load characteristics.

When Si is used as the negative electrode active material, Si is expanded and contracted by the charge and discharge reaction and new active material surface is formed. It is considered that the active material surface thus formed has high activity. If sufficient amount of LiBF₄ is not present in the electrolyte when the active material surface is formed, the surface of the negative electrode is not sufficient coated due to decomposition of LiBF₄. It becomes impossible to obtain good cycle characteristics for a long period.

It is considered that, when vinylene carbonate is present in the electrolyte, the decomposition reactions of LiBF₄ and vinylene carbonate on the Si active material surface proceed simultaneously and the charge and discharge cycle proceeds while limiting the decomposition reaction of LiBF₄ to the minimum degree. Therefore, it is considered that, in the charge and discharge cycle for a long period, sufficient amount of LiBF₄ is present in the electrolytic solution and cycle characteristics can be obtained for a long period.

<Test 4>

### Example 10

In the same manner as in Example 2, except that, in a mixed solvent prepared by mixing ethylene carbonate (EC) with diethyl carbonate (DEC) in a volume ratio of 3:7, LiBF₄ (0.5 mol/liter) and LiPF₆ (0.7 mol/liter) as electrolyte salts were dissolved to prepare an electrolytic solution, a battery of Example 10 was produced. In the battery of Example 10, the concentration of LiBF₄ in the electrolyte is 0.2 mol/liter more than the concentration in Example 2

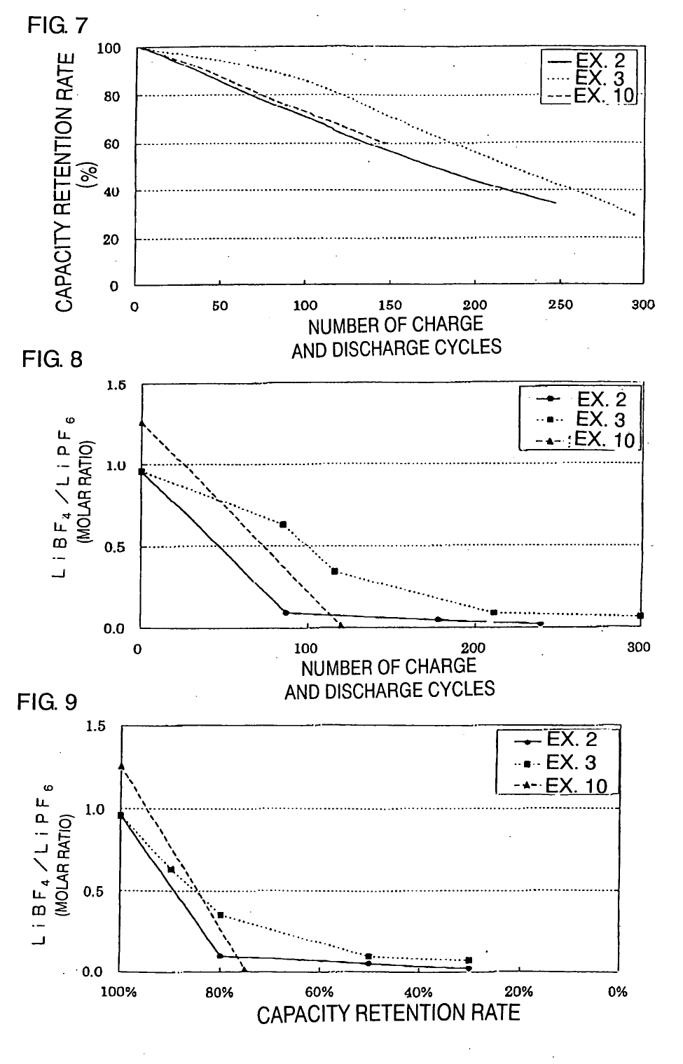

FIG. 7 is a graph showing the relation between the number of charge and discharge cycles and the capacity retention rate in Example 10. In FIG. 7, Example 2 and Example 3 are also shown. As is apparent from FIG. 7, the capacity retention rate in Example 10 is slightly more than that in case of Example 2, and charge and discharge cycle characteristics are inferior as compared with Example 3.

FIG. 8 is a graph showing a relation between the number of charge and discharge cycles and the molar ratio LiBF₄/LiPF₆ in the electrolyte in Examples 10, 2 and 3. FIG. 9 is a graph showing a relation between the capacity retention rate and the molar ratio LiBF₄/LiPF₆ in the electrolyte in Examples 10, 2 and 3. As shown in FIG. 8 and FIG. 9, Example 10 contains a large amount of LiBF₄ as compared with Example 2 and Example 3, however, the concentration of LiBF₄ drastically decreased as the charge and discharge cycle proceeds, similar to Example 2. The concentration of LiBF₄ is 0.14 mol/liter (M) when the capacity retention rate in Example 10 is 80% and the residual amount to the initial concentration is 20%.

Therefore, even if the initial concentration of LiBF₄ increases, the concentration of LiBF₄ drastically decreased as the charge and discharge cycle proceeds, similar to Example 2. Therefore, as shown in FIG. 7, charge and discharge cycle characteristics are deteriorated as compared with Example 3. Therefore, it is found to be effective to add vinylene carbonate in the electrolyte so as to make up for consumption of LiBF₄ during charge and discharge cycle, as compared with the addition of a large amount of LiBF₄ in the electrolyte at an initial stage. It is considered that coexistence of LiBF₄ and vinylene carbonate in the electrolyte specifically exerts a synergistic effect thereby to improve cycle characteristics.

1. A non-aqueous electrolyte secondary battery comprising a negative electrode made of a negative electrode active material containing silicon, a positive electrode, and a non-aqueous electrolyte containing an electrolyte salt and a solvent, wherein
a first electrolyte salt containing boron and fluorine and a second electrolyte salt having a decomposition rate on the surface of the negative electrode during charging and discharging, which is lower than that of the first electrolyte salt, are used as the electrolyte salt.

2. The non-aqueous electrolyte secondary battery according to claim 1, wherein the non-aqueous electrolyte contains LiBF₄ as the first electrolyte salt.

3. The non-aqueous electrolyte secondary battery according to claim 1, wherein the non-aqueous electrolyte contains at least one of LiPF₆, LiN(SO₂C₂F₅)₂ and LiN(SO₂CF₃)₂ as the second electrolyte salt.

4. The non-aqueous electrolyte secondary battery according to claim 1, wherein the negative electrode is provided by forming a thin film containing silicon on a negative electrode current collector using a CVD method, a sputtering method, an evaporation method, a thermal spraying method or a plating method.

5. The non-aqueous electrolyte secondary battery according to claim 4, wherein the thin film is separated in a columnar shape by a nick formed in the thickness direction and the bottom portion of the columnar portion is closely contacted with the negative electrode current collector.

6. The non-aqueous electrolyte secondary battery according to claim 1, wherein the content of the first electrolyte salt in the non-aqueous electrolyte during battery assembling is within a range from 0.1 to 2.0 mol/liter.

7. The non-aqueous electrolyte secondary battery according to claim 1, wherein the content of the second electrolyte salt in the non-aqueous electrolyte during battery assembling is within a range from 0.1 to 1.5 mol/liter.

8. The non-aqueous electrolyte secondary battery according to claim 1, wherein the non-aqueous electrolyte contains vinylene carbonate.

9. The non-aqueous electrolyte secondary battery according to claim 8, wherein the content of vinylene carbonate in the non-aqueous electrolyte is within a range from 0.1 to 10% by weight.

10. The non-aqueous electrolyte secondary battery according to claim 8, wherein the concentration of LiBF₄ in the non-aqueous electrolyte when the discharge capacity is reduced to 80% of the initial discharge capacity after charge and discharge cycle is 10% higher than the concentration before charge and discharge cycle.

11. The non-aqueous electrolyte secondary battery according to claim 8, wherein the concentration of LiBF₄ in the non-aqueous electrolyte when the discharge capacity is reduced to 80% of the initial discharge capacity after charge and discharge cycle is higher than 0.05 mol/liter.
